(19) United States
(12) Patent Application Publication
(10) Pub. No.: US 2021/0390423 A1
(43) Pub. Date: Dec. 16, 2021

(54) DEEP FUSION REASONING ENGINE FOR TIME SERIES ANALYSIS

(71) Applicant: Cisco Technology, Inc., San Jose, CA (US)

(72) Inventors: Hugo Latapie, Long Beach, CA (US); Carlos M. Pignataro, Cary, NC (US); Guillaume Sauvage De Saint Marc, Sevres (FR); Ozkan Kilic, Long Beach, CA (US); Andrew Albert Pletcher, Scotts Valley, CA (US)

(21) Appl. No.: 17/102,095

(22) Filed: Nov. 23, 2020

Related U.S. Application Data
(60) Provisional application No. 63/038,431, filed on Jun. 12, 2020.

(51) Int. Cl. G06N 5/02; H04L 12/26

(52) U.S. Cl. CPC G06N 5/025; H04L 43/0876

(57) ABSTRACT

In one embodiment, a reasoning engine executed by a device, identifies one or more structural breaks in a time series for a particular metric regarding a computer network. The reasoning engine associates the one or more structural breaks in the time series data with a network event. The reasoning engine determines, using symbolic reasoning, a root cause for the network event based on a symbolic knowledge base maintained by the reasoning engine. The reasoning engine provides an indication of the determined root cause for the network event to one or more devices.

### RELATED APPLICATION

This application claims priority to U.S. Provisional Pat. App. Ser. No. 63/038,431, filed Jun. 12, 2020, entitled “DEEP FUSION REASONING ENGINE FOR TIME SERIES ANALYSIS,” by Latapie et al., the contents of which are incorporated by reference herein.

### TECHNICAL FIELD

The present disclosure relates generally to computer networks, and, more particularly, to a deep fusion reasoning engine (DFRE) for time series analysis.

### BACKGROUND

Time series monitoring and analysis can provide considerable insights into the health of a network. This is true for various contexts, such as Quality of Service (QoS), Information Quality (IQ). Quality of Experience (QoE), etc., as well as ensuring that the network is operating in a reliable manner. Indeed, sudden changes in a time series, such as structural breaks, can indicate various problems in the behavior of the network.

While there are many ways to detect changes in time series, identifying the root cause of the change is far more challenging. This is particularly true in the case of computer networks, where a time series of metrics from one device may be influenced by other time series on that device or even on other devices. For instance, changes in the time series for an application-level metric may be correlated with the time series for other metrics at the overlay, underlay, data-link, or physical layers, as well. In other words, an event can manifest its impact across various categories and planes.

To date, understanding the causal connections between events and the different categories of events is often left to human experts. This can lead to events and network conditions going undetected or misdiagnosed. While machine learning can aid in the above time series and correlation analyses, explainability is still a key requirement to adopting more automated network monitoring approaches.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example computer network;

FIG. 2 illustrates an example network device/node;

FIG. 3 illustrates an example hierarchy for a deep fusion reasoning engine (DFRE);

FIGS. 4A-4B illustrates an example DFRE architecture for time series analysis;

FIG. 5 illustrates an example of various inference types;

FIG. 6 illustrates an example architecture for multiple DFRE agents;

FIG. 7 illustrates an example DFRE metamodel;

FIGS. 8A-8C illustrate examples of using structural breaks in time series to define intervals;

FIG. 9 illustrates an example of the projection of knowledge onto structural breaks of time series;

FIGS. 10A-10B illustrate examples of clustering time series to identify events;

FIGS. 11A-11B illustrate the operations at L2 of the DFRE metamodel;

FIGS. 12A-12D illustrates examples of different events and their relationships;

FIG. 13 illustrates an example of zooming in on a region of interest;

FIGS. 14A-14C illustrate examples of the identification and isolation of service or application problems using a DFRE; and

FIG. 15 illustrates an example simplified procedure for using a DFRE to analyze a time series.

### DESCRIPTION OF EXAMPLE EMBODIMENTS

### Overview

According to one or more embodiments of the disclosure, a reasoning engine executed by a device, identifies one or more structural breaks in a time series for a particular metric regarding a computer network. The reasoning engine associates the one or more structural breaks in the time series data with a network event. The reasoning engine determines, using symbolic reasoning, a root cause for the network event based on a symbolic knowledge base maintained by the reasoning engine. The reasoning engine provides an indication of the determined root cause for the network event to one or more devices.

### DESCRIPTION

A computer network is a geographically distributed collection of nodes interconnected by communication links and segments for transporting data between end nodes, such as personal computers, cellular phones, workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to forward data from one network to another.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

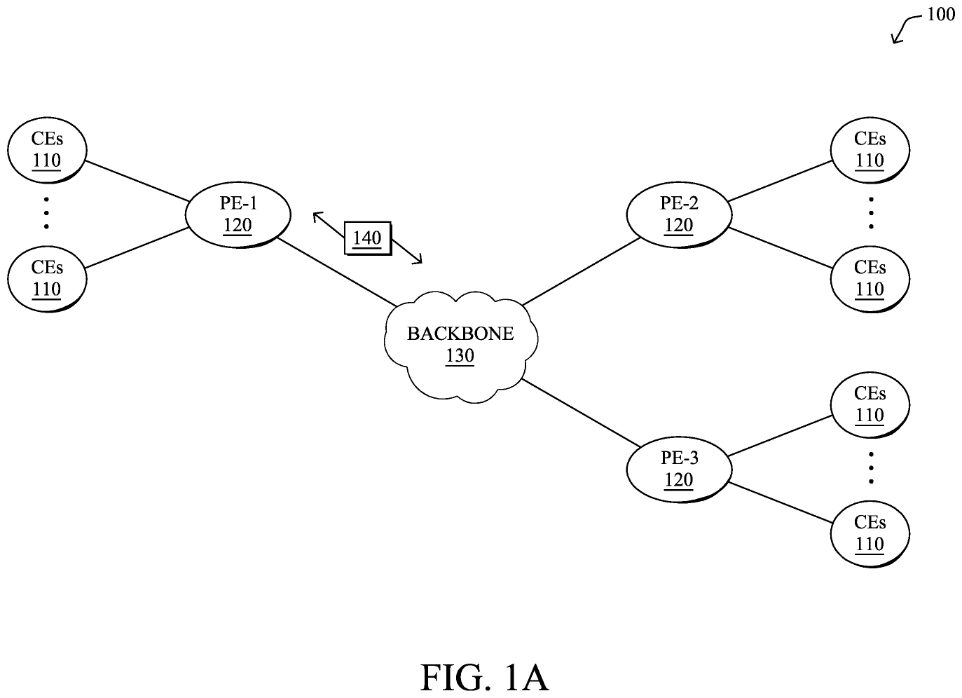

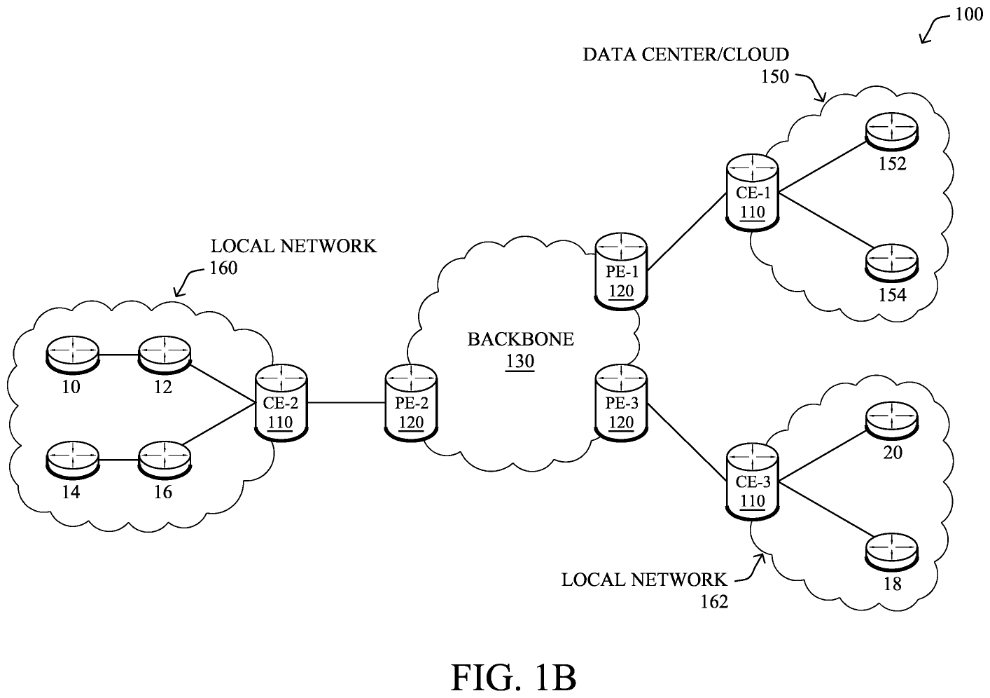

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN utilizing a Service Provider network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.

2.) Site Type B: a site connected to the network using two MPLS VPN links (e.g., from different Service Providers) using a single CE router, with potentially a backup link (e.g., a 3G/4G/5G/LTE connection). A site of type B may itself be of different types:

2a.) Site Type B1: a site connected to the network using two MPLS VPN links (e.g., from different Service Providers), with potentially a backup link (e.g., a 3G/4G/5G/LTE connection).

2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

In various embodiments, network 100 may include one or more mesh networks, such as an Internet of Things network. Loosely, the term “Internet of Things” or “IoT” refers to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Notably, shared-media mesh networks, such as wireless or PLC networks, etc., are often deployed on what are referred to as Low-Power and Lossy Networks (LLNs), which are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen to thousands or even millions of LLN routers, and support point-to-point traffic (between devices inside the LLN), point-to-multipoint traffic (from a central control point such at the root node to a subset of devices inside the LLN), and multipoint-to-point traffic (from devices inside the LLN towards a central control point). Often, an IoT network is implemented with an LLN-like architecture. For example, as shown, local network 160 may be an LLN in which CE-2 operates as a root node for nodes/devices 10-16 in the local mesh, in some embodiments.

In contrast to traditional networks, LLNs face a number of communication challenges. First, LLNs communicate over a physical medium that is strongly affected by environmental conditions that change over time. Some examples include temporal changes in interference (e.g., other wireless networks or electrical appliances), physical obstructions (e.g., doors opening/closing, seasonal changes such as the foliage density of trees, etc.), and propagation characteristics of the physical media (e.g., temperature or humidity changes, etc.). The time scales of such temporal changes can range between milliseconds (e.g., transmissions from other transceivers) to months (e.g., seasonal changes of an outdoor environment). In addition, LLN devices typically use low-cost and low-power designs that limit the capabilities of their transceivers. In particular, LLN transceivers typically provide low throughput. Furthermore, LLN transceivers typically support limited link margin, making the effects of interference and environmental changes visible to link and network protocols. The high number of nodes in LLNs in comparison to traditional networks also makes routing, quality of service (QoS), security, network management, and traffic engineering extremely challenging, to mention a few.

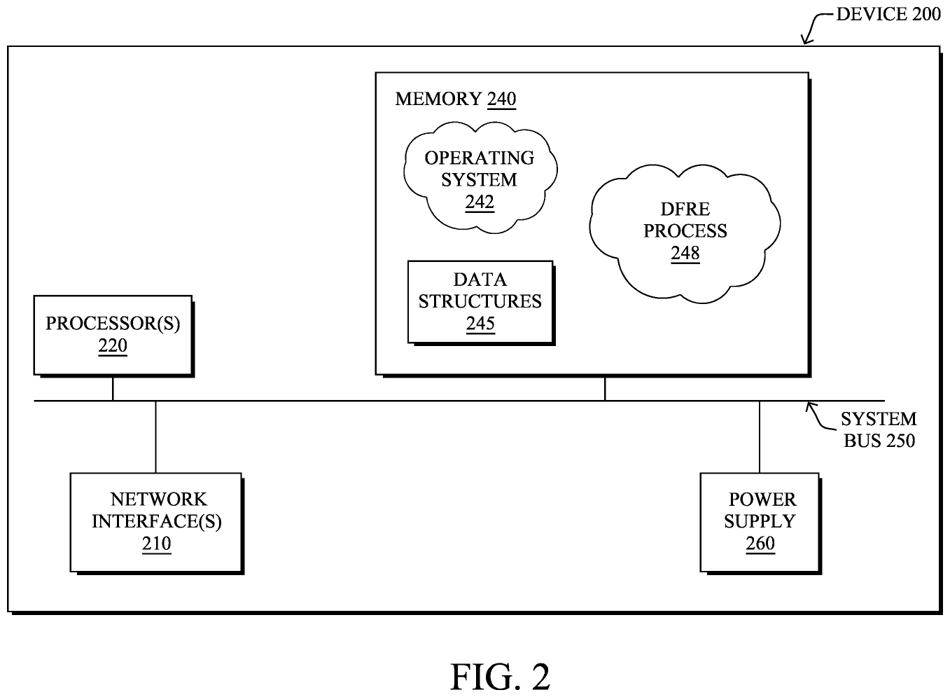

FIG. 2 is a schematic block diagram of an example node/device 200 that may be used with one or more embodiments described herein, e.g., as any of the computing devices shown in FIGS. 1A-1B, particularly the PE routers 120, CE routers 110, nodes/device 10-20, servers 152-154 (e.g., a network controller located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise a deep fusion reasoning engine (DFRE) process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

DFRE process 248 includes computer executable instructions that, when executed by processor(s) 220, cause device 200 to provide cognitive reasoning services to a network. In various embodiments, DFRE process 248 may utilize machine learning techniques, in whole or in part, to perform its analysis and reasoning functions. In general, machine learning is concerned with the design and the development of techniques that take as input empirical data (such as network statistics and performance indicators) and recognize complex patterns in these data. One very common pattern among machine learning techniques is the use of an underlying model M, whose hyper-parameters are optimized for minimizing the cost function associated to M, given the input data. The learning process then operates by adjusting the hyper-parameters such that the number of misclassified points is minimal. After this optimization phase (or learning phase), the model M can be used very easily to classify new data points. Often, M is a statistical model, and the minimization of the cost function is equivalent to the maximization of the likelihood function, given the input data.

In various embodiments, DFRE process 248 may employ one or more supervised, unsupervised, or self-supervised machine learning models. Generally, supervised learning entails the use of a training large set of data, as noted above, that is used to train the model to apply labels to the input data. For example, the training data may include sample video data that depicts a certain object and is labeled as such. On the other end of the spectrum are unsupervised techniques that do not require a training set of labels. Notably, while a supervised learning model may look for previously seen patterns that have been labeled as such, an unsupervised model may instead look to whether there are sudden changes in the behavior. Self-supervised is a representation learning approach that eliminates the pre-requisite requiring humans to label data. Self-supervised learning systems extract and use the naturally available relevant context and embedded metadata as supervisory signals. Self-supervised learning models take a middle ground approach: it is different from unsupervised learning as systems do not learn the inherent structure of data, and it is different from supervised learning as systems learn entirely without using explicitly-provided labels.

Example machine learning techniques that DFRE process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), multi-layer perceptron (MLP) artificial neural networks (ANNs) (e.g., for non-linear models), replicating reservoir networks (e.g., for non-linear models, typically for time series), random forest classification, or the like. Accordingly, DFRE process 248 may employ deep learning, in some embodiments. Generally, deep learning is a subset of machine learning that employs ANNs with multiple layers, with a given layer extracting features or transforming the outputs of the prior layer.

The performance of a machine learning model can be evaluated in a number of ways based on the number of true positives, false positives, true negatives, and/or false negatives of the model. For example, the false positives of the model may refer to the number of times the model incorrectly identified an object or condition within a video feed. Conversely, the false negatives of the model may refer to the number of times the model failed to identify an object or condition within a video feed. True negatives and positives may refer to the number of times the model correctly determined that the object or condition was absent in the video or was present in the video, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

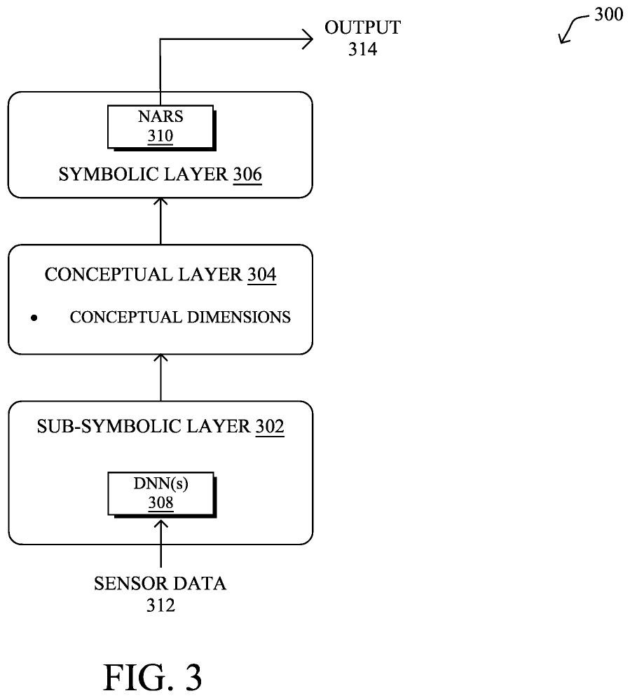

According to various embodiments, FIG. 3 illustrates an example hierarchy 300 for a deep fusion reasoning engine (DFRE). For example, DFRE process 248 shown in FIG. 2 may execute a DFRE for any number of purposes. In particular, DFRE process 248 may be configured to analyze sensor data in an IoT deployment (e.g., video data, etc.), to analyze networking data for purposes of network assurance, control, enforcing security policies and detecting threats, facilitating collaboration, and the like.

In general, a reasoning engine, also known as a ‘semantic reasoner,’ ‘reasoner,’ or ‘rules engine,’ is a specialized form of machine learning software that uses asserted facts or axioms to infer consequences, logically. Typically, a reasoning engine is a form of inference engine that applies inference rules defined via an ontology language. As introduced herein, a DFRE is an enhanced form of reasoning engine that further leverages the power of sub-symbolic machine learning techniques, such as neural networks (e.g., deep learning), allowing the system to operate across the full spectrum of sub-symbolic data all the way to the symbolic level.

At the lowest layer of hierarchy 300 is sub-symbolic layer 302 that processes the sensor data 312 collected from the network. For example, sensor data 312 may include video feed/stream data from any number of cameras located throughout a location. In some embodiments, sensor data 312 may comprise multimodal sensor data from any number of different types of sensors located throughout the location. At the core of sub-symbolic layer 302 may be one or more DNNs 308 or other machine learning-based model that processes the collected sensor data 312. In other words, sub-symbolic layer 302 may perform sensor fusion on sensor data 312 to identify hidden relationships between the data.

At the opposing end of hierarchy 300 may be symbolic layer 306 that may leverage symbolic learning. In general, symbolic learning includes a set of symbolic grammar rules specifying the representation language of the system, a set of symbolic inference rules specifying the reasoning competence of the system, and a semantic theory containing the definitions of “meaning.” This approach differs from other learning approaches that try to establish generalizations from facts as it is about reasoning and extracting knowledge from knowledge. It combines knowledge representations and reasoning to acquire and ground knowledge from observations in a non-axiomatic way. In other words, in sharp contrast to the sub-symbolic learning performed in layer 302, the symbolic learning and generalized intelligence performed at symbolic layer 306 requires a variety of reasoning and learning paradigms that more closely follows how humans learn and are able to explain why a particular conclusion was reached.

Symbolic learning models what are referred to as “concepts,” which comprise a set of properties. Typically, these properties include an “intent” and an “extent,” whereby the intent offers a symbolic way of identifying the extent of the concept. For example, consider the intent that represents motorcycles. The intent for this concept may be defined by properties such as “having two wheels” and “motorized,” which can be used to identify the extent of the concept (e.g., whether a particular vehicle is a motorcycle).

Linking sub-symbolic layer 302 and symbolic layer 306 may be conceptual layer 304 that leverages conceptual spaces. In general, conceptual spaces are a proposed framework for knowledge representation by a cognitive system on the conceptual level that provides a natural way of representing similarities. Conceptual spaces enable the interaction between different type of data representations as an intermediate level between sub-symbolic and symbolic representations.

More formally, a conceptual space is a geometrical structure which is defined by a set of quality dimensions to allow for the measurement of semantic distances between instances of concepts and for the assignment of quality values to their quality dimensions, which correspond to the properties of the concepts. Thus, a point in a conceptual space S may be represented by an n-dimensional conceptual vector v=<d₁, . . . , dᵢ, . . . , dₙ> where dᵢ represents the quality value for the i^{th} quality dimension. For example, consider the concept of taste. A conceptual space for taste may include the following dimensions: sweet, sour, bitter, and salty, each of which may be its own dimension in the conceptual space. The taste of a given food can then be represented as a vector of these qualities in a given space (e.g., ice cream may fall farther along the sweet dimension than that of peanut butter, peanut butter may fall farther along the salty dimension than that of ice cream, etc.). By representing concepts within a geometric conceptual space, similarities can be compared in geometric terms, based on the Manhattan distance between domains or the Euclidean distance within a domain in the space. In addition, similar objects can be grouped into meaningful conceptual space regions through the application of clustering techniques, which extract concepts from data (e.g., observations).

Said differently, a conceptual space is a framework for representing information that models human-like reasoning to compose concepts using other existing concepts. Note that these representations are not competing with symbolic or associationistic representations. Rather, the three kinds can be seen as three levels of representations of cognition with different scales of resolution and complementary. Namely, a conceptual space is built up from geometrical representations based on a number of quality dimensions that complements the symbolic and deep learning models of symbolic layer 306 and sub-symbolic layer 302, representing an operational bridge between them. Each quality dimension may also include any number of attributes, which present other features of objects in a metric subspace based on their measured quality values. Here, similarity between concepts is just a matter of metric distance between them in the conceptual space in which they are embedded.

In other words, a conceptual space is a geometrical representation which allows the discovery of regions that are physically or functionally linked to each other and to abstract symbols used in symbolic layer 306, allowing for the discovery of correlations shared by the conceptual domains during concepts formation. For example, an alert prioritization module may use connectivity to directly acquire and evaluate alerts as evidence. Possible enhancements may include using volume of alerts and novelty of adjacent (spatially/temporally) alerts, to tune level of alertness.

In general, the conceptual space at conceptual layer 304 allows for the discovery of regions that are naturally linked to abstract symbols used in symbolic layer 306. The overall model is bi-directional as it is planned for predictions and action prescriptions depending on the data causing the activation in sub-symbolic layer 302.

Layer hierarchy 300 shown is particularly appealing when matched with the attention mechanism provided by a cognitive system that operates under the assumption of limited resources and time-constraints. For practical applications, the reasoning logic in symbolic layer 306 may be non-axiomatic and constructed around the assumption of insufficient knowledge and resources (AIKR). It may be implemented, for example, with a Non-Axiomatic Reasoning System (open-NARS) 310. However, other reasoning engines can also be used, such as Auto-catalytic Endogenous Reflective Architecture (AERA), OpenCog, and the like, in symbolic layer 306, in further embodiments. Even Prolog may be suitable, in some cases, to implement a reasoning engine in symbolic layer 306. In turn, an output 314 coming from symbolic layer 306 may be provided to a user interface (UI) for review. For example, output 314 may comprise a video feed/stream augmented with inferences or conclusions made by the DFRE, such as the locations of unstocked or under-stocked shelves, etc.

By way of example of symbolic reasoning, consider the ancient Greek syllogism: (1.) All men are mortal, (2.) Socrates is a man, and (3.) therefore, Socrates is mortal. Depending on the formal language used for the symbolic reasoner, these statements can be represented as symbols of a term logic. For example, the first statement can be represented as “man→[mortal]” and the second statement can be represented as “{Socrates}→man.” Thus, the relationship between terms can be used by the reasoner to make inferences and arrive at a conclusion (e.g., “Socrates is mortal”). Non-axiomatic reasoning systems (NARS) generally differ from more traditional axiomatic reasoners in that the former applies a truth value to each statement, based on the amount of evidence available and observations retrieved, while the latter relies on axioms that are treated as a baseline of truth from which inferences and conclusions can be made.

In other words, a DFRE generally refers to a cognitive engine capable of taking sub-symbolic data as input (e.g., raw or processed sensor data regarding a monitored system), recognizing symbolic concepts from that data, and applying symbolic reasoning to the concepts, to draw conclusions about the monitored system.

As noted above, time series analysis can provide significant insights into the health and operation of a computer network. However, simply identifying changes in the time series of a measurement/metric from the network does not provide enough information to make these assessments. In addition, different events indicated by the time series may be related, making diagnosis of the underlying issue particularly challenging. For instance, a memory leak on an upstream router could result in route instabilities, packet loss or delays, and the like. As a result, their corresponding time series may also exhibit certain characteristics.

### Deep Fusion Reasoning Engine (DFRE) for Time Series Analysis

The techniques herein introduce a deep fusion reasoning engine (DFRE) for time series analysis. In various embodiments, the techniques herein provide for the following benefits, among others:

1.) Application and service problem identification and isolation

2.) Network troubleshooting/self-healing and optimization

3.) User experience optimization

4.) Calculating a reliability index for the network

5.) Equal Cost Multipath (ECMP) load optimization.

Illustratively, the techniques described herein may be performed by hardware, software, and/or firmware, such as in accordance with the DFRE process 248, which may include computer executable instructions executed by the processor 220 (or independent processor of interfaces 210), to perform functions relating to the techniques described herein.

Specifically, according to various embodiments, a reasoning engine executed by a device, identifies one or more structural breaks in a time series for a particular metric regarding a computer network. The reasoning engine associates the one or more structural breaks in the time series data with a network event. The reasoning engine determines, using symbolic reasoning, a root cause for the network event based on a symbolic knowledge base maintained by the reasoning engine. The reasoning engine provides an indication of the determined root cause for the network event to one or more devices.

Operationally, the DFRE framework introduced herein leverage semantic focus of attention (FOA) to optimize the analysis of large-scale time series. In various embodiments, this can be done based on structural breaks in individual time series and relationships between these structural breaks among various time series. These structural breaks can be identified using linear and/or non-linear models. In addition, a causal model may be created based on observations and prior knowledge. This model may be represented as a DFRE knowledge graph and/or network simulation, as described in greater detail below. In addition, the DFRE framework introduced herein provides the context within which analysis can be performed by providing parameters, appropriate subsets of the time series, and initial causal hypothesis.

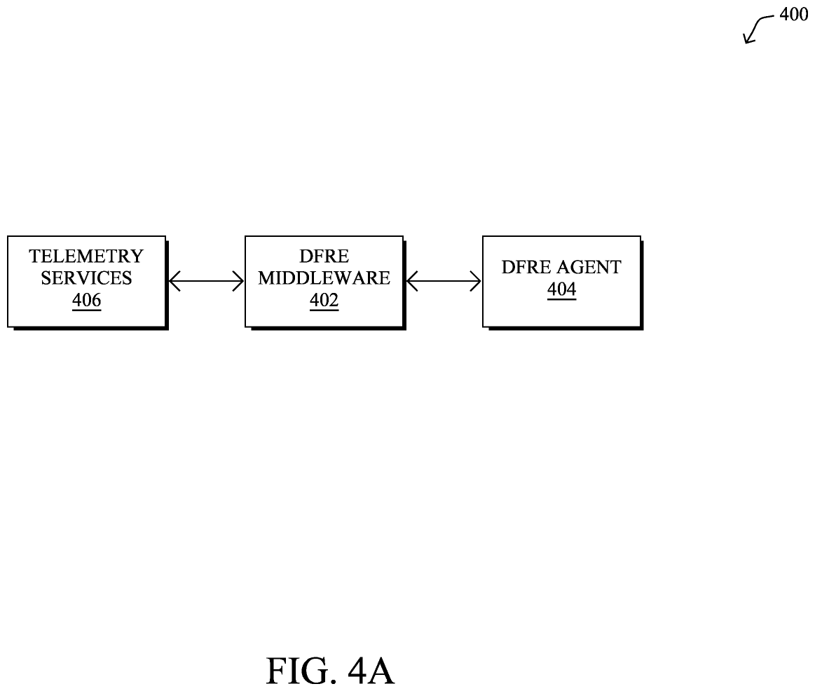

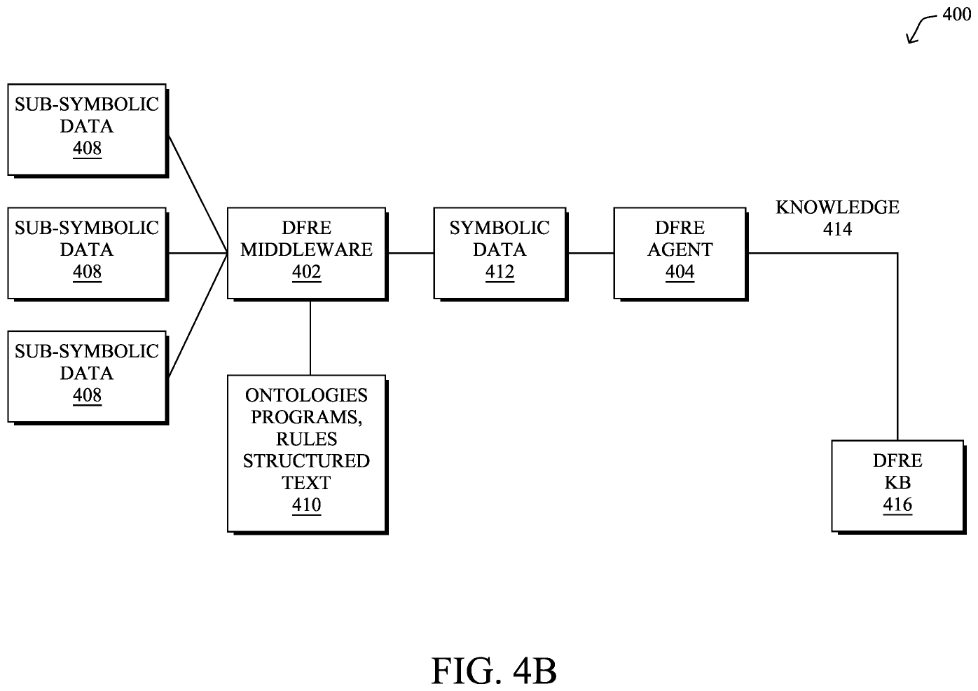

According to various embodiments, FIGS. 4A-4B illustrate an example DFRE architecture 400 for time series analysis. As shown in FIG. 4A, architecture 400 may be implemented across any number of devices, such as in a network undergoing monitoring, partially at a remote location (e.g., in the cloud), or fully remote to the network.

At the core of architecture 400 may be DFRE middleware 402 that offers a collection of services, each of which may have its own interface. In general, DFRE middleware 402 may leverage a library for interfacing, configuring, and orchestrating each service of DFRE middleware 402.

In one embodiment, the services provided by DFRE middleware 402 may utilize telemetry services 406, which are used to collect various forms of telemetry data from a network. For example, telemetry services 406 may collect telemetry data regarding the network via probing, Netflow or IPFIX records, log information, model driven telemetry (MDT) and/or event-driven telemetry (e.g., Yang data), device information, or the like. In other embodiments, telemetry services 406 may provide raw and/or processed telemetry data to DFRE middleware 402.

In various embodiments, DFRE middleware 402 may also provide services to support semantic reasoning, such as by an AIKR reasoner. For example, as shown, DFRE middleware 402 may include a NARS agent that performs semantic reasoning for structural learning. In other embodiments, OpenCog or another suitable AIKR semantic reasoner could be used.

One or more DFRE agents 404 may interface with DFRE middleware 402 to orchestrate the various services available from DFRE middleware 402. In addition, DFRE agent 404 may feed and interact with the AIKR reasoner so as to populate and leverage a DFRE knowledge graph with knowledge.

FIG. 4B illustrates the operation of architecture 400 in greater detail, according to various embodiments. As shown, DFRE middleware 402 may obtain sub-symbolic data 408 (e.g., from telemetry services 404), such as time series data for any number of measured or computed values. In turn, DFRE middleware 402 may leverage various ontologies, programs, rules, and/or structured text 410 to translate sub-symbolic data 408 into symbolic data 412 for consumption by DFRE agent 404. This allows DFRE agent 404 to apply symbolic reasoning to symbolic data 412, to populate and update a DFRE knowledge base (KB) 416 with knowledge 414 regarding the problem space (e.g., the network under observation, etc.). In addition, DFRE agent 404 can leverage the stored knowledge 414 in DFRE KB 416 to make assessments about the network, such as by diagnosing performance issues and the like.

For example, DFRE agent 404 may perform semantic graph decomposition on DFRE KB 416 (e.g., a knowledge graph), so as to compute a graph from the knowledge graph of KB 416 that addresses a particular problem. DFRE agent 404 may also perform post-processing on DFRE KB 416, such as performing graph cleanup, applying deterministic rules and logic to the graph, and the like. DFRE agent 404 may further employ a definition of done, to check goals and collect answers using DFRE KB 416.

In general, DFRE KB 416 may comprise any or all of the following:
is a Data
Ontologies
Evolutionary steps of reasoning
Knowledge (e.g., in the form of a knowledge graph)
The Knowledge graph also allows different reasoners to:
   a Have their internal subgraphs
   Share or coalesce knowledge
   Work cooperatively

In other words, DFRE KB 416 acts as a dynamic and generic memory structure. In some embodiments, DFRE KB 416 may also allow different reasoners to share or coalesce knowledge, have their own internal sub-graphs, and/or work collaboratively in a distributed manner. For example, a first DFRE agent 404 may perform reasoning on a first sub-graph, a second DFRE agent 404 may perform reasoning on a second sub-graph, etc., to evaluate the health of the network and/or find solutions to any detected problems. To communicate with DFRE agent 404, DFRE KB 416 may include a bidirectional Narsese interface or other interface using another suitable grammar.

In various embodiments, DFRE KB 416 can be visualized on a user interface. For example, Cytoscape, which has its building blocks in bioinformatics and genomics, can be used to implement graph analytics and visualizations.

Said differently, DFRE architecture 400 may include any or all of the following the following components:
DFRE middleware 402 that comprises:
   Structural learning component
   JSON, textual data, ML/DL pipelines, and/or other containerized services (e.g., using Docker)
   Hierarchical goal support
DFRE Knowledge Base (KB) 416 that supports:
   Bidirectional Narseseese interface
   Semantic graph decomposition algorithms
   Graph analytics
   Visualization services
DFRE Agent 404
   DFRE Control System

More specifically, in some embodiments, DFRE middleware 402 may include any or all of the following:
Subsymbolic services:
   Telemetry Data Services to support and collect time series metrics from the network
   Telemetry Data Time Series Analytics Services
Reasoner(s) for structural learning
NARS
OpenCog
Optimized hierarchical goal execution
   Probabilistic programming
   Causal inference engines
a Visualization Services (e.g., Cytoscape, etc.)

DFRE middleware 402 may also allow the addition of new services needed by different problem domains.

During execution, DFRE agent 404 may, thus, perform any or all of the following:
Orchestration of services
Focus of attention
   Semantic graph decomposition
      Addresses combinatorial issues via an automated divide and conquer approach that works even in non-separable problems because we compute a graph covering that allows for overlap.
Feeding and interacting with the AIKR reasoner via bidirectional translation layer to the DFRE knowledge graph.
   Call middleware services
Post processing of the graph
   Graph clean-up
   Apply deterministic rules and logic to the graph
Definition of Done (DoD)
   Check goals and collect answers

In various embodiments, DFRE agent 404 may also leverage data available from out of band sources, such as news feeds, social media, etc., and/or geo-fenced information, such as where the sources of the telemetry data time series are located. For instance, DFRE agent 404 may receive and assess information such as a video of an accident in a power plant in City X from a social media feed, an indication of a curfew in City X from a news feed, information regarding new Internet data privacy regulations in City X's state, geolocation information associated with the sub-symbolic data 408 (e.g., time series of network metrics, etc.), and the like.

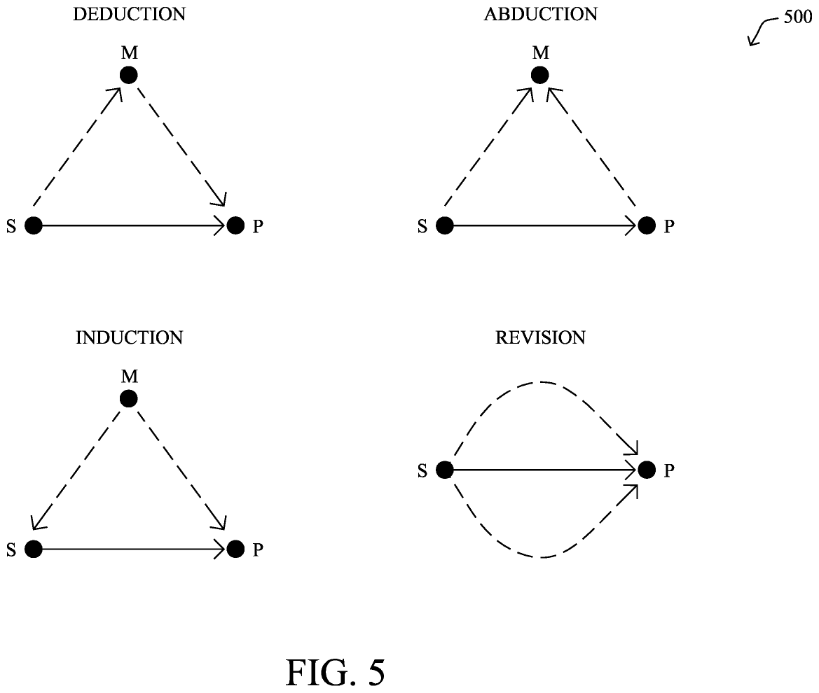

FIG. 5 illustrates an example 500 showing the different forms of structural learning that the DFRE framework can employ. More specifically, the inference rules in example 500 relate premises S→M and M→P, leading to a conclusion S→P. Using these rules, the structural learning herein can be implemented using an ontology with respect to an Assumption of Insufficient Knowledge and Resources (AIKR) reasoning engine, as noted previously. This allows the system to rely on finite processing capacity in real time and be prepared for unexpected tasks. More specifically, as shown, the DFRE may support any or all of the following:
Syllogistic Logic
   Logical quantifiers
Various Reasoning Types
   Deduction Induction
   Abduction
   Induction
   Revision
Different Types of Inference
Local inference
Backward inference

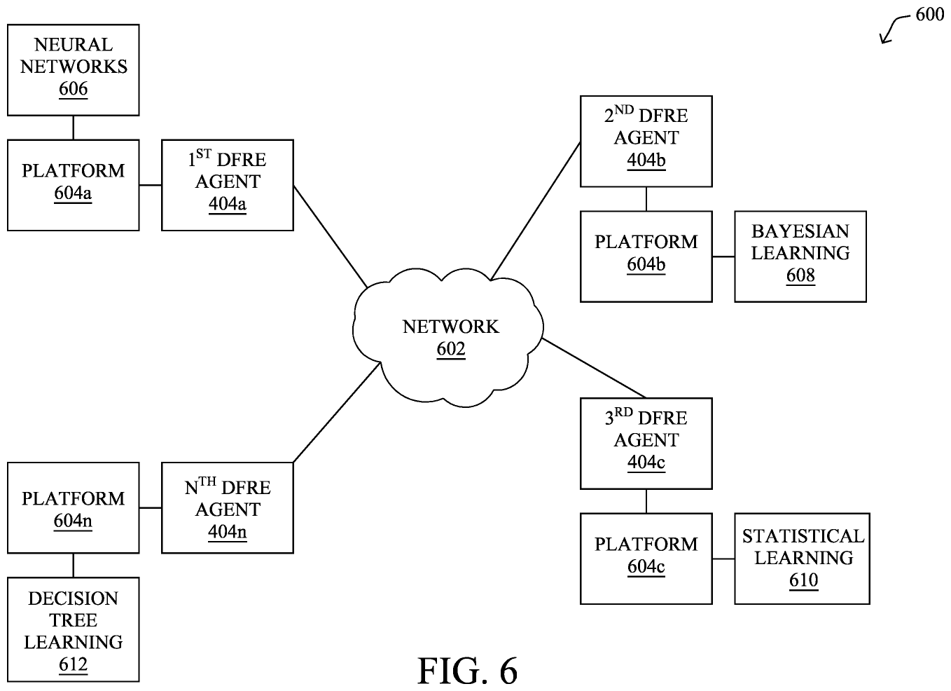

To address combinatorial explosion, the DFRE knowledge graph may be partitioned such that each partition is processed by one or more DFRE agents 404, as shown in FIG. 6, in some embodiments. More specifically, any number of DFRE agents 404 (e.g., a first DFRE agent 404a through an N^{th} DFRE agent 404n) may be executed by devices connected via a network 602 or by the same device. In some embodiments, DFRE agents 404a-404n may be deployed to different platforms (e.g., platforms 604a-604n) and/or utilize different learning approaches. For instance, DFRE agent 404a may leverage neural networks 606, DFRE agent 404b may leverage Bayesian learning 608, DFRE agent 404c may leverage statistical learning, and DFRE agent 404n may leverage decision tree learning 612.

As would be appreciated, graph decomposition can be based on any or all of the following:
Spatial relations—for instance, this could include the vertical industry of a customer, physical location (country) of a network, scale of a network deployment, or the like.
Descriptive properties, such as severity, service impact, next step, etc.
Graph-based components (isolated subgraphs, minimum spanning trees, all shortest paths, strongly connected components . . . )
   Any new knowledge and related reasoning steps can also be input back to the knowledge graph, in various embodiments.

In further embodiments, the DFRE framework may also support various user interface functions, so as to provide visualizations, actions, etc. to the user. To do so, the framework may leverage Cytoscape, web services, or any other suitable mechanism.

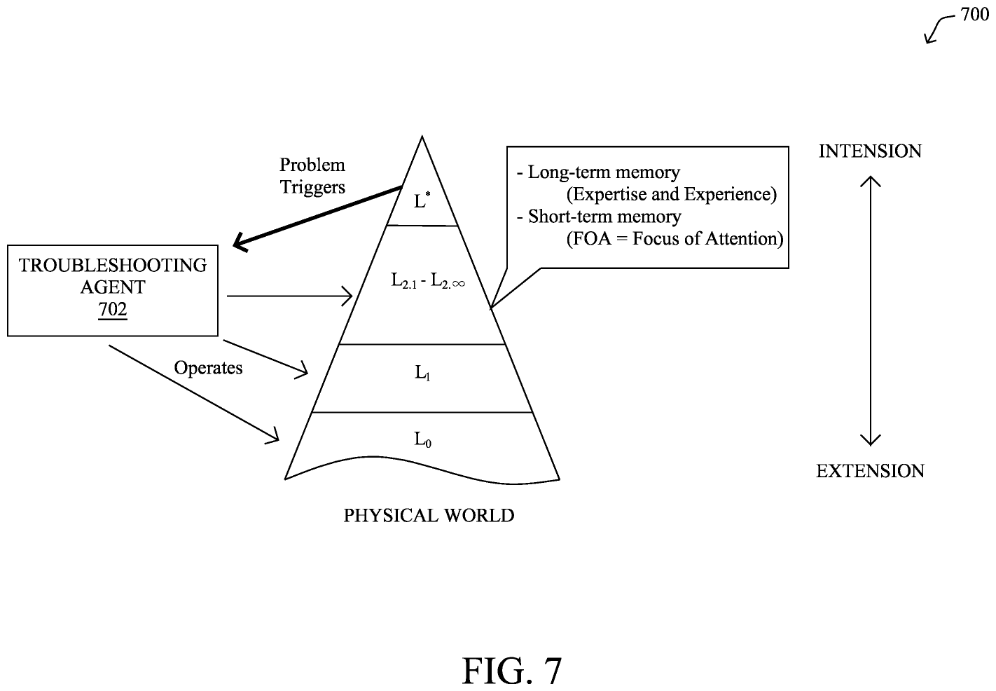

At the core of the techniques herein is a knowledge representation metamodel 700 for different levels of abstraction, as shown in FIG. 7, according to various embodiments. In various embodiments, the DFRE knowledge graph groups information into four different levels, which are labeled L₀, L₁, L₂, and L* and represent different levels of abstraction, with L₀ being closest to raw data coming in from various sensors and external systems (e.g., the telemetry data time series) and L₂ representing the highest levels of abstraction typically obtained via mathematical means such as statistical learning and reasoning. L* can be viewed as the layer where high-level goals and motivations are stored. The overall structure of this knowledge is also based on anti-symmetric and symmetric relations.

One key advantage of the DFRE knowledge graph is that human level domain expertise, ontologies, and goals are entered at the L₂ level. This leads, by definition, to an unprecedented ability to generalize at the L₂ level thus minimizing the manual effort required to ingest domain expertise.

More formally:
L* represents the overall status of the abstraction. In case of a problem, it triggers problem solving in lower layers via a troubleshooting agent 702.
L_{2.1}-L_{2.∞}=Higher level representations of the world in which most of concepts and relations are collapsed into simpler representations. The higher-level representations are domain-specific representations of lower levels.
L₁=has descriptive, teleological and structural information about L₀.
L₀=Object level is the symbolic representation of the physical world.

In various embodiments, L₂ may comprise both expertise and experience stored in long-term memory, as well as a focus of attention (FOA) in short-term memory. In other words, when a problem is triggered at L* (e.g., packet loss during a videoconference), a troubleshooting agent 702 that operates on L₂-L₀ may control the FOA so as to focus on different things (e.g., a particular router, a particular path, etc.).

With respect to applying the DFRE metamodel to time series analysis, the raw time series may be collected at L₀, where there is a high amount of symbolic data, but a low amount of structured knowledge. As would be appreciated, there may be hundreds of thousands or even millions of data points that need to be extracted at L₀. The DFRE's FOA is based on the abstraction and the DFRE knowledge graph (KG) keeps combinatorial explosion under control.

More specifically, structural-stability and structural breaks in time series data can be indicative of important incidents (e.g., in the network) or proper functioning of the real-world system. In some embodiments, structural breaks can indicate important incidents in time-series. Analysis of the time series can be achieved by leveraging the fact that structural breaks that have similar characteristics can be grouped together, e.g., periodic events, in L_{2.x} of the DFRE metamodel. In turn, the relationship(s) between structural breaks across different time series provide critical causal model hypothesis. Suitable types of models that can be used for the structural break analysis include, but are not limited to, linear, exponential, gaussian, neural network models, etc., in various embodiments.

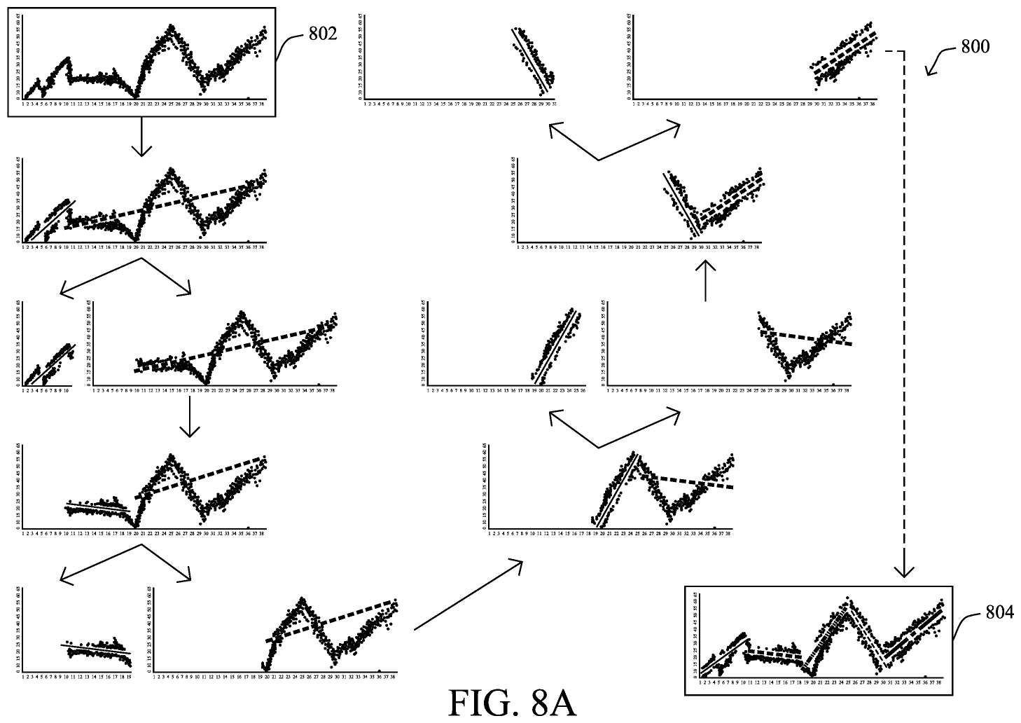

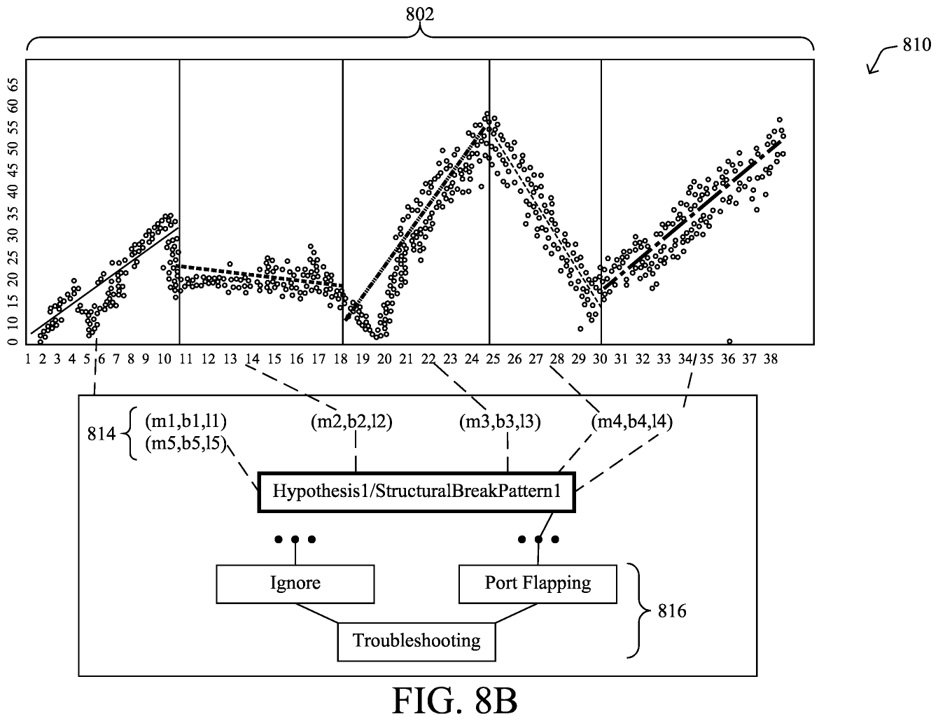

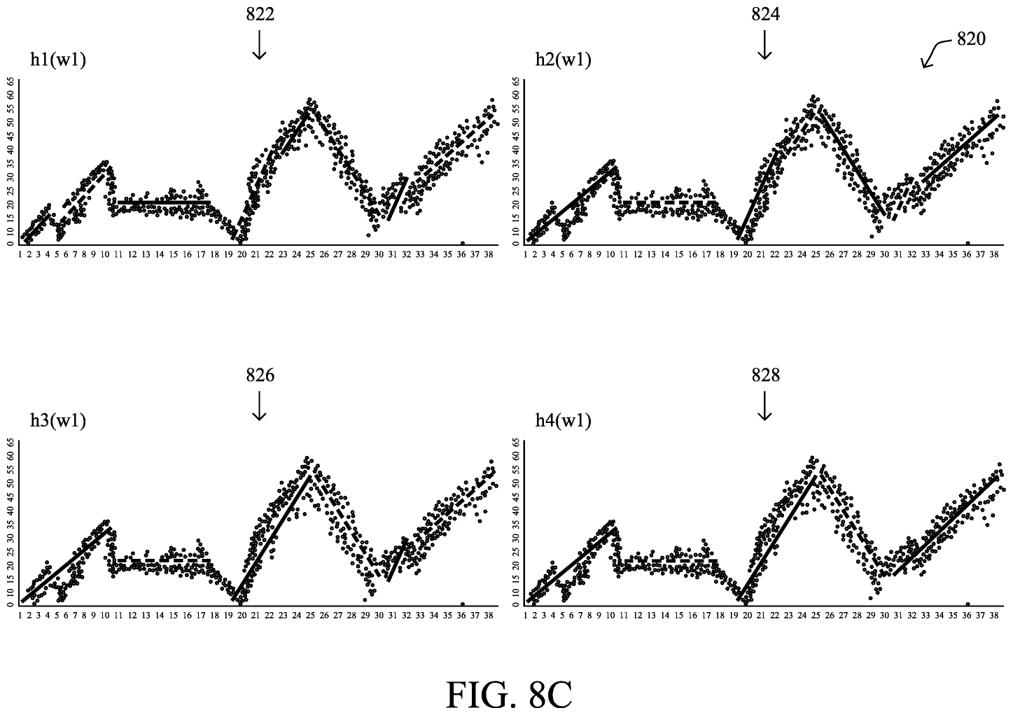

FIGS. 8A-8C illustrate examples of using structural breaks in time series to define intervals. As shown in example 800 in FIG. 8A, a time series 802 may be decomposed into a series of windows of interest, such as by applying a binary segmentation algorithm to time series 802. Each window of interest may exhibit a different pattern and may be divided by structural breaks. By continually attempting to divide time series 802 into different segments, a finalized division 804 may be produced.

In example 810 in FIG. 8B, in some embodiments, the DFRE may use hypothesis testing to find the ‘best’ structural break in time series 802, thereby defining a window of interest. More specifically, consider time series 812 that has multiple structural breaks. M-number of data points from time series 812 may be mapped into the five windows of interest shown, using multiple hypothesis testing (e.g., to assess different linear decompositions of time series 812). For instance, F-stats (Chow test) and line equations may be used to test the quality of a structural break hypothesis.

More specifically, let a particular line be represented using the following equation:

y=mx+b

where m is the slope of the line tested by the hypothesis testing and b is the y-axis intercept. In turn, (m, b, l) triplets 814 may be normalized to represent each linear regression per interval. From this, the DFRE may identify and evaluate potential root causes 816.

As shown in FIG. 8C, the DFRE may treat each linear decomposition as a hypothesis explaining the time series data. For instance, as shown, the DFRE may generate and compare a set 820 of different decompositions/hypotheses 822-828, to identify the ‘best’ decomposition among set 820 (and their covariant and contravariant). The intra-time series and inter-time series structural breaks, correlations between structural breaks and their patterns provide high level knowledge that DFRE represents as L₂ level knowledge in the metamodel, described previously with respect to FIG. 7.

Said different, the DFRE may leverage competing hypothesis testing, to identify a particular linear decomposition as best representing the time series. Here, the hypotheses correlating in slopes, length, and time are indications of inter-time-series structure, meaning a better linear decomposition. The intra-time series and inter-time series structural breaks, correlations between structural breaks, and their patterns provide high level knowledge that DFRE represents as L₂ level knowledge, according to the DFRE metamodel.

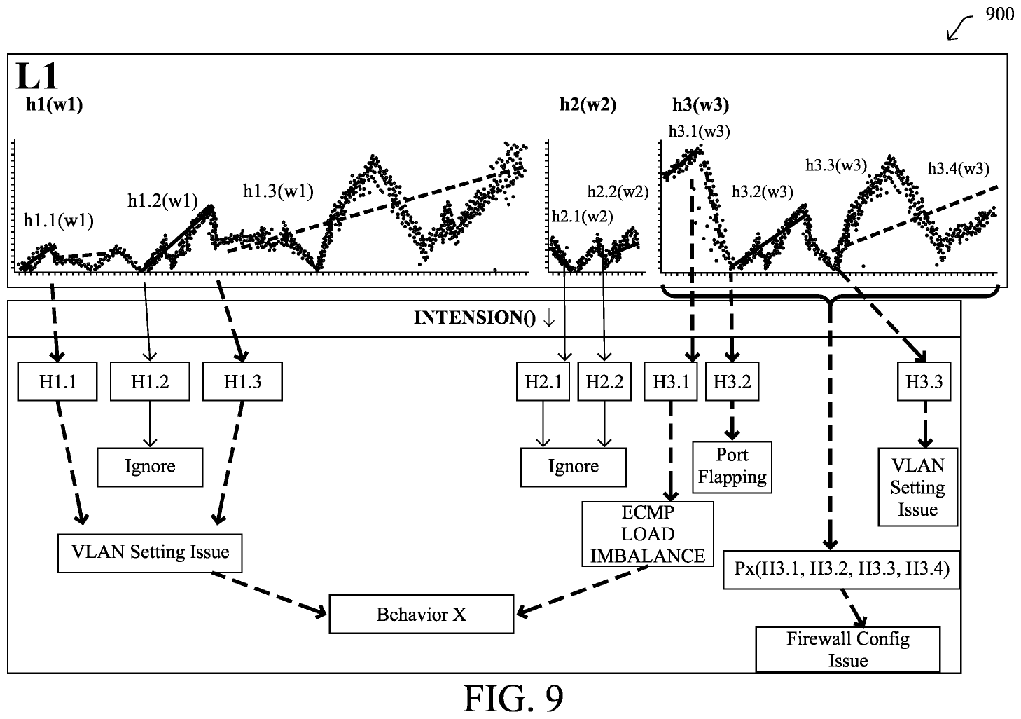

FIG. 9 illustrates an example 900 of the projection of the L₂ level knowledge of the DFRE onto the identified structural breaks across the different decompositions/hypotheses (e.g., the hypotheses 822-828 from FIG. 8). This allows the DFRE to associate the structural breaks with different network events or behaviors. For instance, one structural break may indicate an ECMP load imbalance, while another may indicate port flapping.

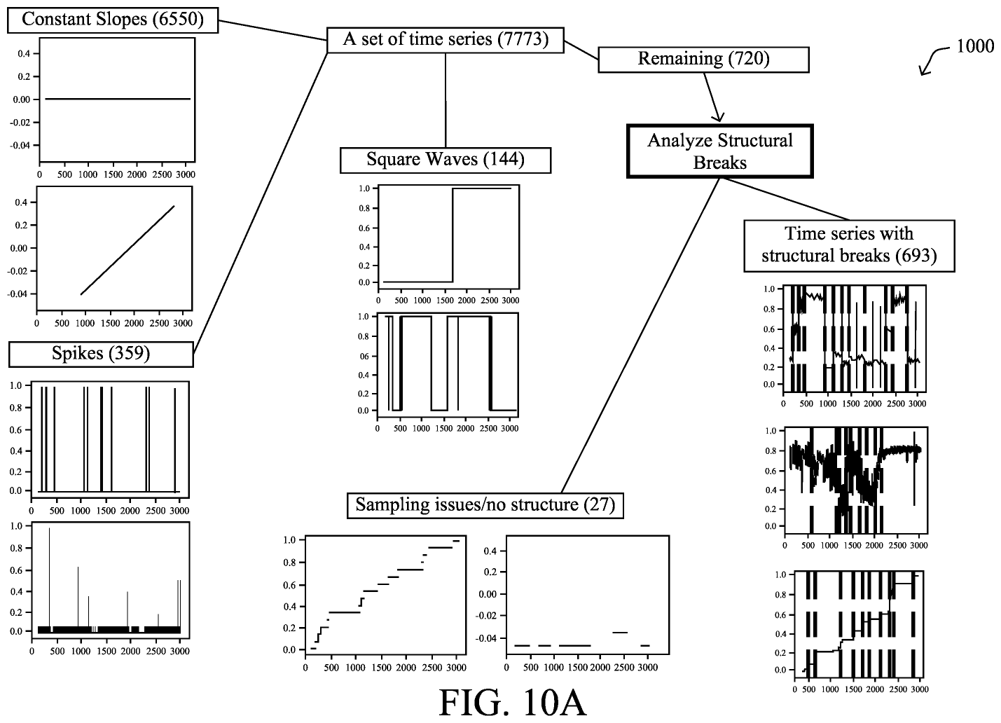

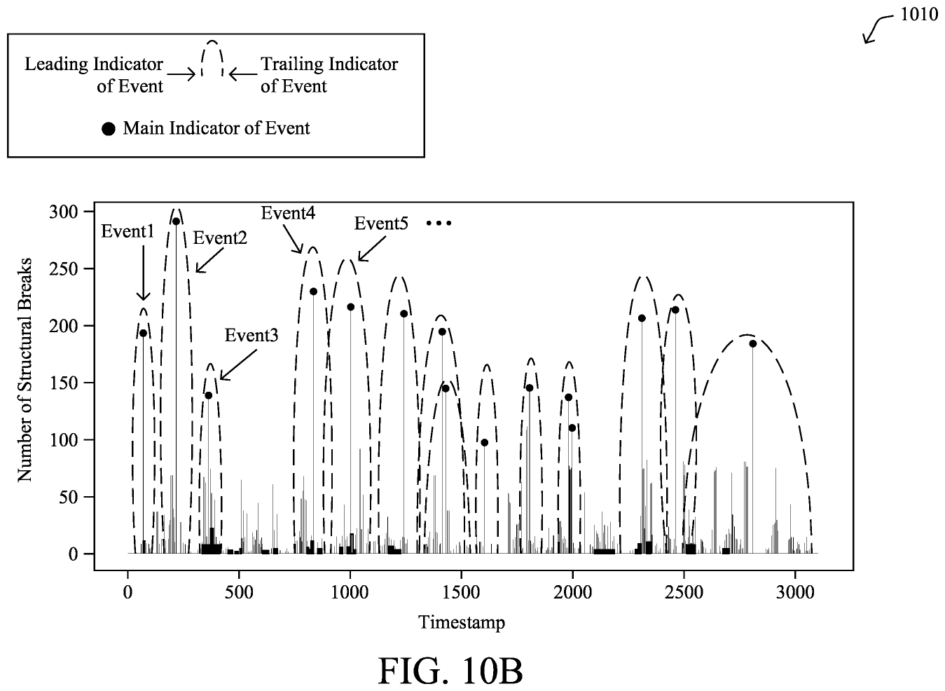

In some embodiments, the DFRE may cluster the identified structural breaks in the time series, to help identify their associated events or behaviors, according to various embodiments. For instance, FIG. 10A illustrates an example 1000 of the clustering of different types of structural breaks observed across a set of time series. More specifically, a total of 7,773 time series were analyzed for structural breaks and their identified behaviors clustered. To do so, the structural breaks were ordered by their F-statistics from a Chow test. In addition, linear model parameters were compared, in some cases, to eliminate less usable structural breaks.

More specifically, of 7,773 time series assessed, constant slopes were observed 6,550 times, spikes were observed 359, and square wave patterns were observed 144 times. The remaining 720 behaviors were then analyzed for structural breaks, resulting in the identification of 693 structural breaks and 27 were classified as ‘sampling issues/no structure.’

To help cluster time series by their structural breaks, the DFRE may form histograms relating the timestamps of the time series to the number of structural breaks that they exhibit, in some embodiments. For example, consider a set of time series all exhibiting structural breaks around the same point of time. This could indicate that the root cause of these changes in behavior are related and caused by the same event or condition.

FIG. 10B illustrates an example histogram 1010 plotting the number of structural breaks observed for a set of time series against their timestamps. In turn, the DFRE may treat large spikes in the histogram as events in the monitored system, such as a monitored network. For instance, the DFRE may identify Events 1-5, etc. shown in FIG. 10B.

To help distinguish between the trailing indicator of an event (e.g., Event1 in FIG. 10B) and the leading indicator of the next event (e.g., Event2), the DFRE may check for evidence in future events. For instance, Event6 may have the same pattern (motifs) as Event1. Other correlating knowledge may be in L₂.

In general, the temporal order of events can be immediately consecutive, parallel, partially overlapping, or intermittent. To this end, the DFRE may hold multiple hypotheses for the temporal structure of events. As it accumulates more evidence, the best-fit hypothesis wins. In addition, different DFRE Agents may assess different hypotheses, using different techniques, and accumulate knowledge. For instance, a DFRE Agent may use matrix profile to detect anomalies or motifs, Dynamic Time Warping (DTW) to correlate, Generalized AutoRegressive Conditional Heteroskedasticity (GARCH), AutoRegressive Integrated Moving Average (ARIMA) to forecast, etc., once the context is set by the agent. In some cases, behaviors can also be identified as composite events, e.g., a sequence of individual events can cause a repeating pattern across the time series.

In some embodiments, the DFRE may represent the profile of a time series with structural breaks in matrix form. Indeed, some motifs (e.g., patterns) are repeating in nature, allowing the DFRE to represent the repeating motifs as matrix entries. In addition, the DFRE may identify certain discords (e.g., anomalies) from within these patterns.

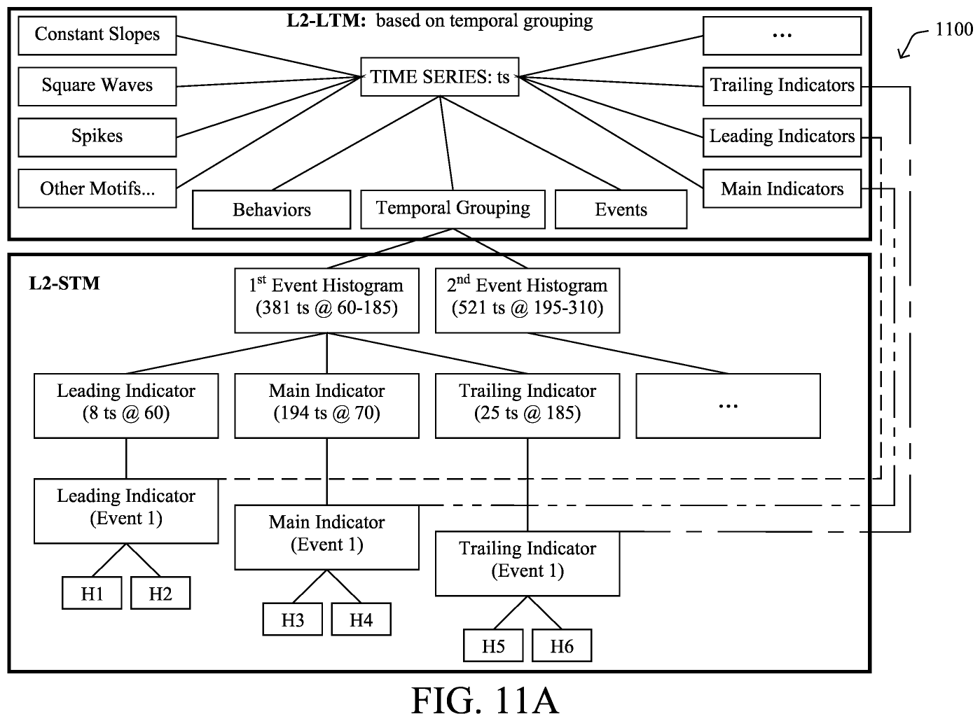

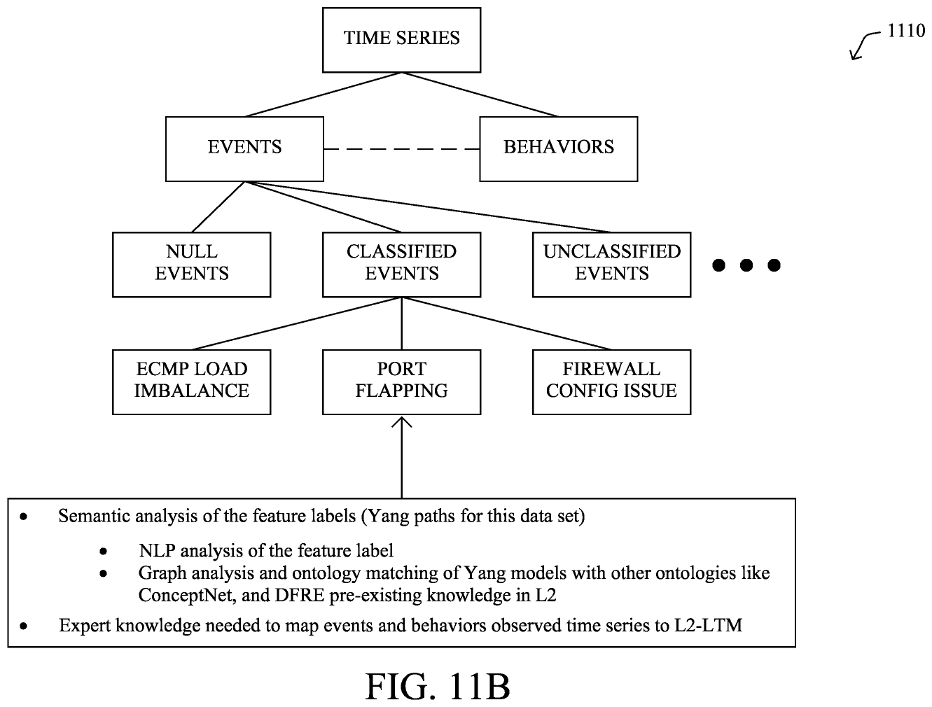

FIGS. 11A-11B illustrate examples 1100 and 1110, respectively, of the L₂ processing of time series in the DFRE, according to various embodiments. As shown, expert knowledge may be leveraged to map events and behaviors observed time series to L2-LTM of the DFRE metamodel (e.g., metamodel 700 in FIG. 7). In turn, the DFRE may apply semantic analysis to the feature labels, such as by using natural language processing (NLP) analysis of the feature labels and/or graph analysis and ontology matching of Yang models with other ontologies like the ConceptNet ontology and/or other ontologies, as well as by leveraging pre-existing knowledge in L₂ of the metamodel.

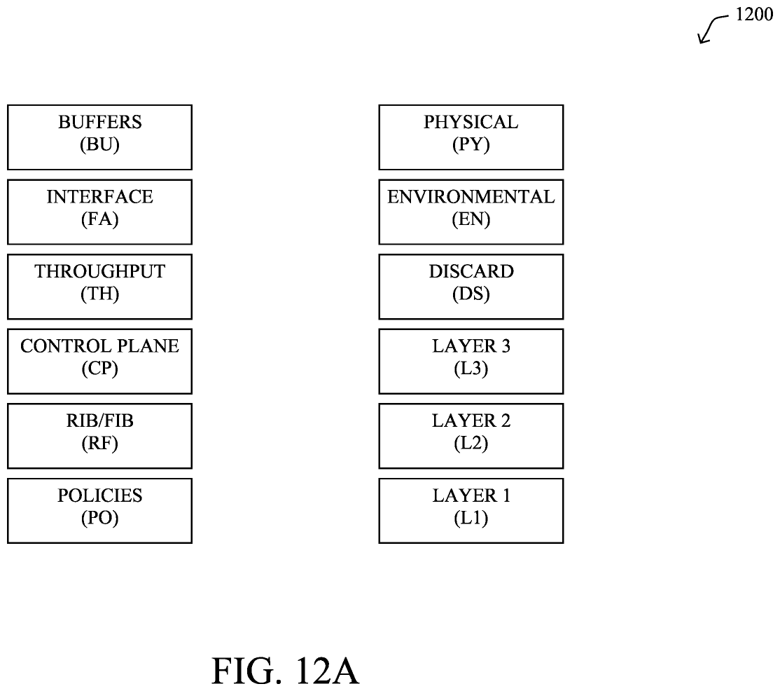

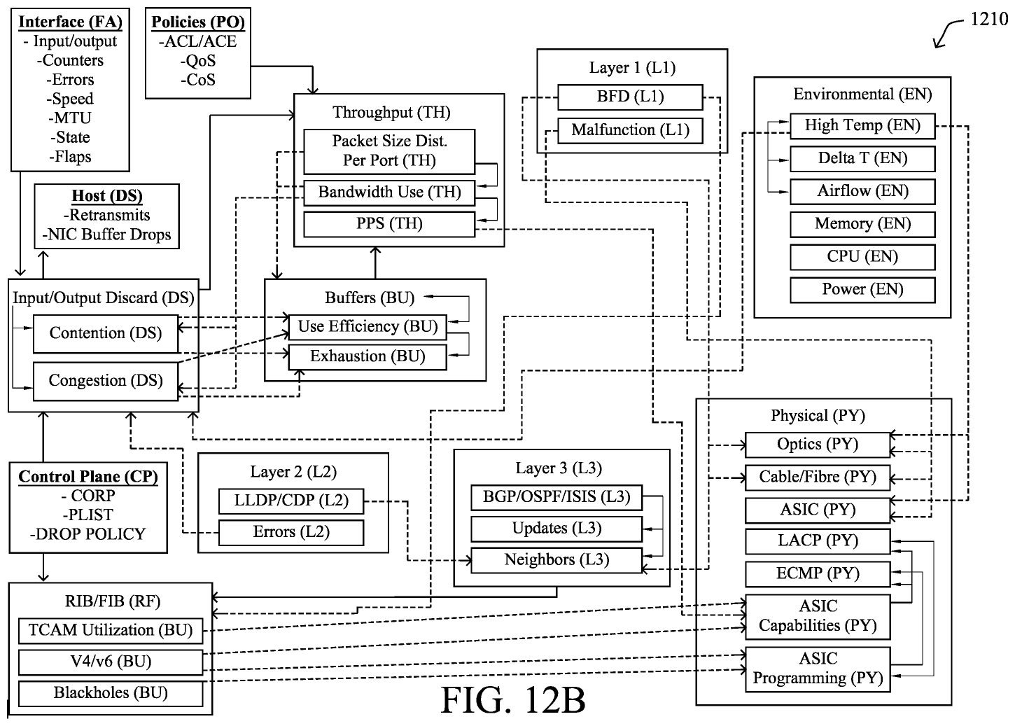

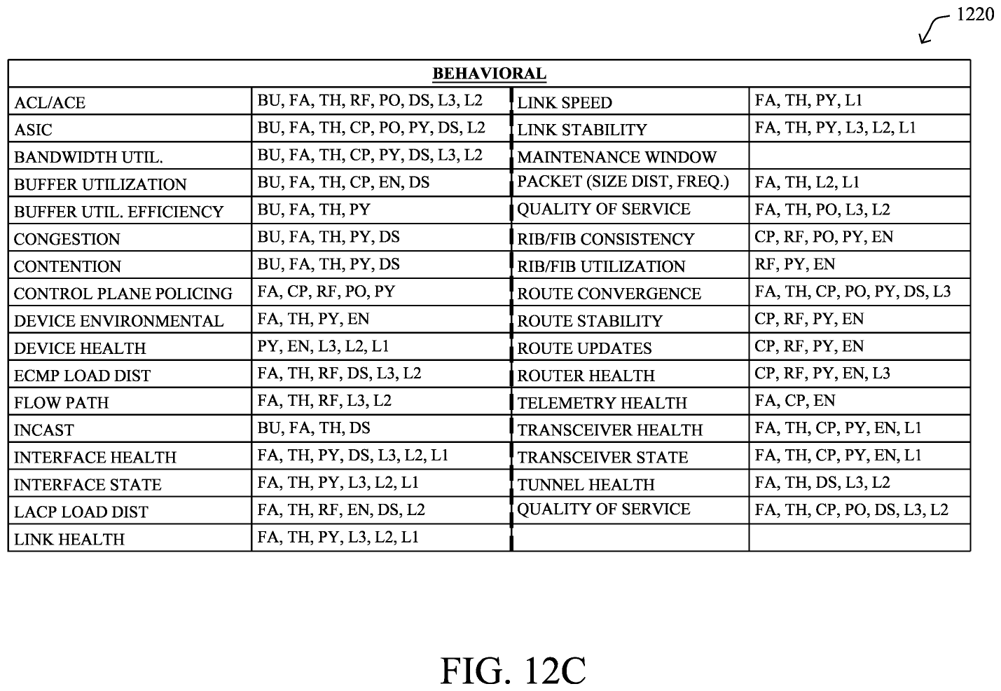

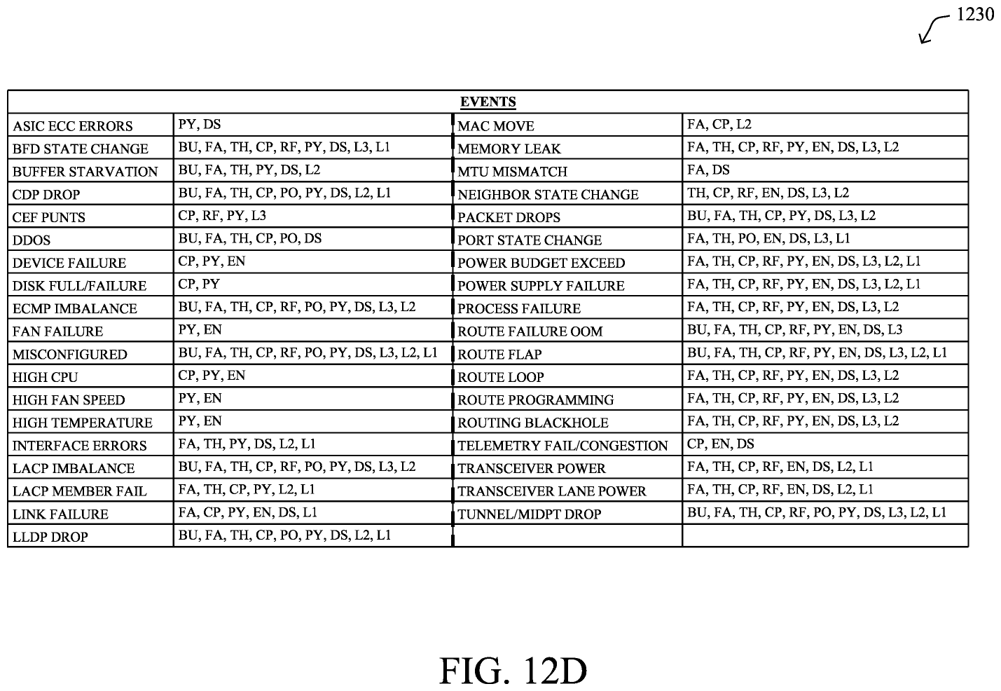

FIGS. 12A-12D illustrate examples of different events and their relationships, according to various embodiments. As shown in FIG. 12A, various events 1200 may be defined for the DFRE when the DFRE is used to assess issues in a computer network. Note that events 1600 can manifest their impacts in different categories and planes of the network (e.g., the control pane, etc.) and can cause specific behaviors in the network or on a certain device. It is also important for the DFRE to understand how these categories are causally related and need to be represented in L2-LTM, so that their relationships can be learned in a probabilistic manner (e.g., using Problog, simulators, experts, etc.). This helps the DFRE to learn unseen events by using the causal and categoric relations between the seen events. FIG. 12B illustrates an example 1210 of such causal connections that can be supplied to the DFRE using domain knowledge by an expert. Likewise, FIGS. 12C-12D illustrates an example 1220 of the causal connections and event categories across different behaviors and events.

According to various embodiments, the names of the various time series can be used to provide even more information to the DFRE. In turn, the DFRE may extract the leading indicator, main indicator, and trailing indicator of a particular event from a given time series (e.g., based on its structural breaks).

To accumulate knowledge, the DFRE may ‘zoom’ between the leading and trailing indicators of the event and repeat this analysis on different timescales on subsets of the time series and/or by using different models (e.g., exponential, Gaussian, ANN, etc.). For instance, one event identified during testing had the following indicators:
1. Change in network traffic
   Normal traffic events
   Seasonality
   Updates changing traffic patterns
2. Maintenance event
   Here, the contexts of the indicators signal that a particular event is probably composed of sub-events, making the zooming operation desirable.

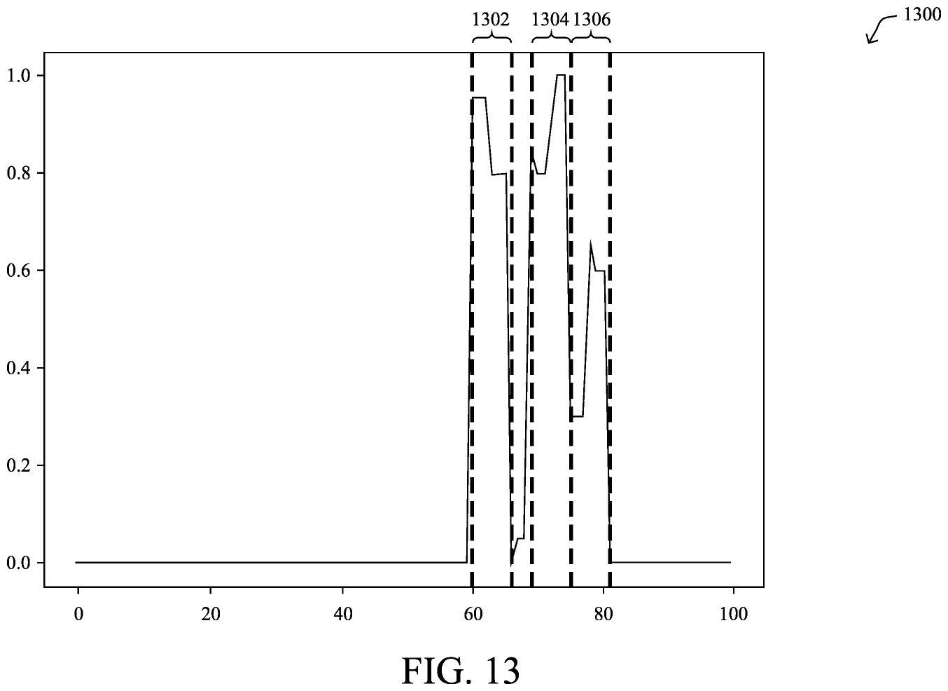

FIG. 13 illustrates an example of zooming in on a region of interest, according to various embodiments. As shown, consider a time series 1300 for which the DFRE has identified a set of breaks occurring in different regions 1302-1306 in time series 1300. Thus, the DFRE may assess time series 1300 as a whole and/or by ‘zooming’ in its focus on a particular region or set of regions of time series 1300.

When ‘zooming’ in on a particular region from among regions 1302-1306 of time series 1300, the order of breaks becomes important. This could lead the DFRE to require additional evidence, such as coincidental sub-events, searching for patterns, using knowledge of the network topology, using probabilistic programming (e.g., Problog, etc.) or the like. To this end, the DFRE may perform additional analysis such as by detecting sub-events, investigating the trailing indicator, identifying the type of event and its pattern, the effects of the event on other time series, and/or assessing the topology of the network.

In some instances, the DFRE may also further analyze time series 1300 to assess the following: 1.) whether the are still sub-events to be evaluated, 2.) when the current event ends (e.g., by investigating its training indicator), 3.) the type of event (e.g., whether it has a pattern) based on expert knowledge, 4.) the effect of the event on other time series, and/or 5.) whether inferences can be made leveraging knowledge of the network topology.

In other words, for the current case, DFRE accumulates knowledge from:
1. Unstructured data sources: Time Series
2. Symbolic data sources: Yang Models
   By using structural break analysis, NLP analysis of the feature labels, graph analysis and ontology matching of Yang models, DFRE can evaluate
the time interval of an event and its indicator
its topics
possible time series to be affected by this event

In some embodiments, the structural break pattern of a time series and possible events may need to be analyzed further by a DFRE Agent. In such cases, the agent may employ a simulator, which is a virtual environment to:
make experiments
test hypotheses (e.g., a causal model across multiple time series)
learn new knowledge

DFRE is aimed to have totally self-controlled learning skills through multiple simulators, which also provide the system with better planning in case of problem solving. Increasing quality of service, quality of information and experience is one of the motivations of DFRE for all processes, including self-supervised experiments. Indeed, having access to the real (observable) world may not be enough, as there can be a hidden state space model rather than observable state model for an issue. The simulation environment allows for abductive process providing creativity.

In other words, the DFRE may try to create a simulation that behaves like the genuine problem in the real word. This is a self-supervised learning loop where DFRE continually tries to predict the present using the recent past of actual life. For instance, this may take the form of a time-shifted DFRE living a few seconds in the past that is trying to predict the current. In such a case, the present becomes the labeled data, which is generated automatically.

As would be appreciated, the DFRE may comprise an L₂ metamodel representation for Quality of Service (Qos), Information Quality (IQ) and Quality of Experience (QoE) metrics for different contexts. Here, QoS relates to the overall performance of the network (e.g., monitoring packet loss, bit rate, throughput, transmission delay, etc.). IQ measures the available information if fit-for-use in an adaptive way (e.g., accuracy, latency, completeness, credibility, security of information, etc.). QoE relates to the overall acceptability of an application/service from the user end (e.g., printing speed, audio dropping, media quality, buffering frequency, etc.). Depending on the results, the DFRE can raise service requests automatically or initiate network self-healing functions.

In addition to the above metrics for the network itself, the DFRE may also leverage internal metrics at L₂ of the DFRE metamodel to guide its meta learning, allowing for models that can learn new skills or adapt to new environments, rapidly. For instance, if these internal QoS, IQ, or QoE metrics are too low for a given hypothesis, the DFRE may change its approach by doing any of the following:
Using a different model for analysis (e.g., exponential, Gaussian, ANN, etc.).
a Testing different causal models.
Seek additional information from out-of-band sources (e.g., diurnal events, seasonal events, geofence information, social media, political events, terror events, pandemics, etc.).

To deal with combinatorial explosion, the DFRE may:
is 1. Selectively process relevant data at each level via abstraction-based focus of attention
2. Apply semantic graph decomposition
   Note that the decomposed data can be still too large or requiring different learning algorithms. In addition, in some embodiments, the DFRE can orchestrate distributed learning data by multiple agents by:
1. working on different platforms with various computing resources
2. utilizing different learning algorithms

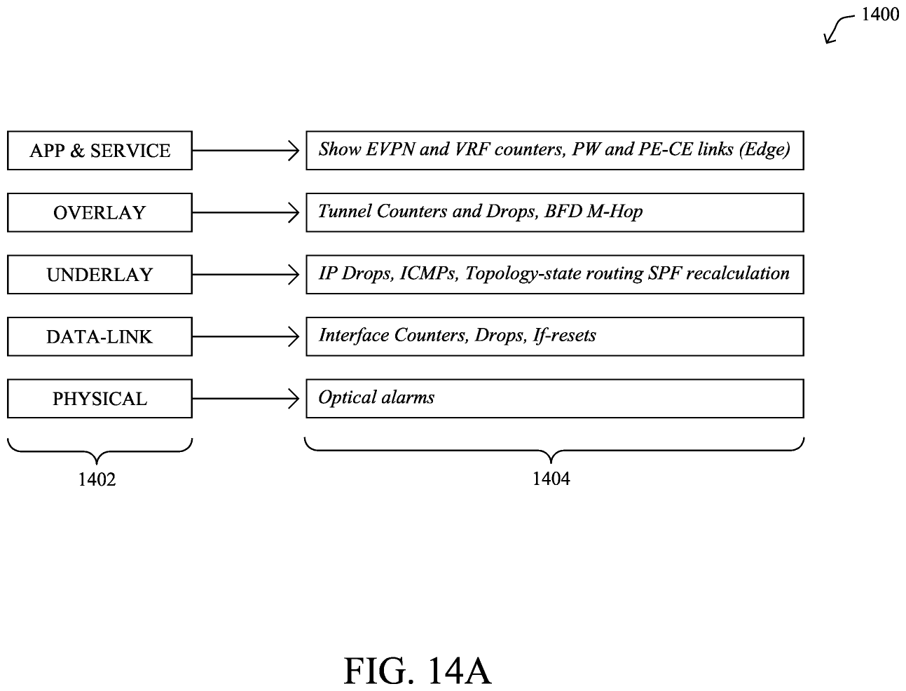

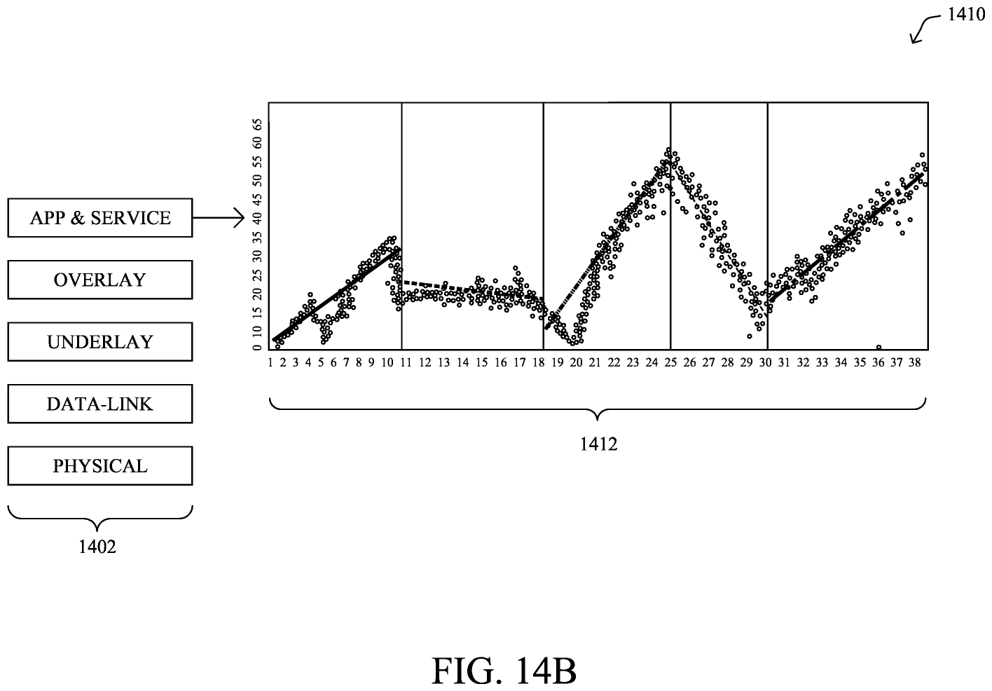

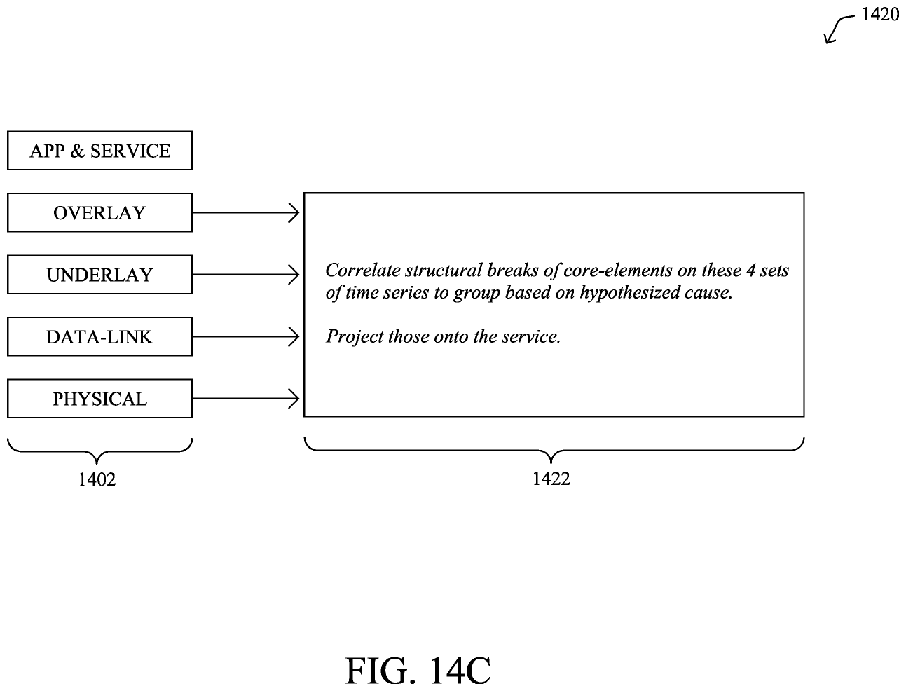

FIGS. 14A-14C illustrate an example of how the DFRE can be used to identify and isolate application and service problems. This can be achieved by:
1. Selecting different time series at different levels of the networking stack, as shown in example 1400 in FIG. 14A. For instance, different time series 1404 may be selected for evaluation at different layers of network stack 1402.
2. Identifying structural breaks and intervals in the service or application, as shown in example 1410 in FIG. 14B. Here, the DFRE may select a time series 1412 selected the applications and services layer of network stack 1402 and identify structural breaks in time series 1412.
3. Projecting knowledge onto the structural breaks, as shown in example 1420 in FIG. 14C. Here, the DFRE may project knowledge 1422 from the lower layers of network stack 1402 onto the structural breaks of time series 1412, to assess a hypothesized cause of those corresponding events.
4. Grouping the OAM (e.g., BFD, S-BFD, optical alarms, etc.) time series segments to provide the layer-based aggregation.

According to various embodiments, another use case for the DFRE techniques introduced herein is to optimize user experience in a network. To do so, the following steps may be taken:
1. Create a mesh of edge-to-edge performance metric probes
2. Identify segments and classify them as high or low experience
3. Correlate the segments to link PPS and capacity interface counters to learn optimal capacity distribution for high experience

In yet another embodiment, the teachings herein can be used to compute a reliability index by:
1. Identifying Service-related (VRF, VPN, EVPN) counters, and find structural discontinuities on outages.
2. Identifying a set of Node-based time series (CPU, Memory, IPC)
3. Correlating outages to the node-based time series, to calculate a coefficient of node reliability characteristics.
4. Building alarm thresholds when those are crossed.

In some cases, this can be extended by:
1. Correlating the networking time series through DFRE, on the structural breaks, for Ticketing System Outages (C3, Jira, CSONE, etc.)
2. SYSLOG:
   1. Creating a Time-Series based on the Severity of SYSLOGS over time. For example, when getting these:
      Time1: % SYS-5-CONFIG_I: Configured from console by vty2 (IP)
      Time2: % LINK-3-UPDOWN: Interface Port-channel1, changed state to up
      then Plot {Time1, 5}; {Time2; 3}
   2. Use this Syslog time-series to correlate outages with the service time-series.

In a further embodiment, the DFRE herein can also be used for ECMP load optimization. This can be implemented in a similar manner as that of the user experience optimization steps above, but focused on ECMP usage instead of service performance.

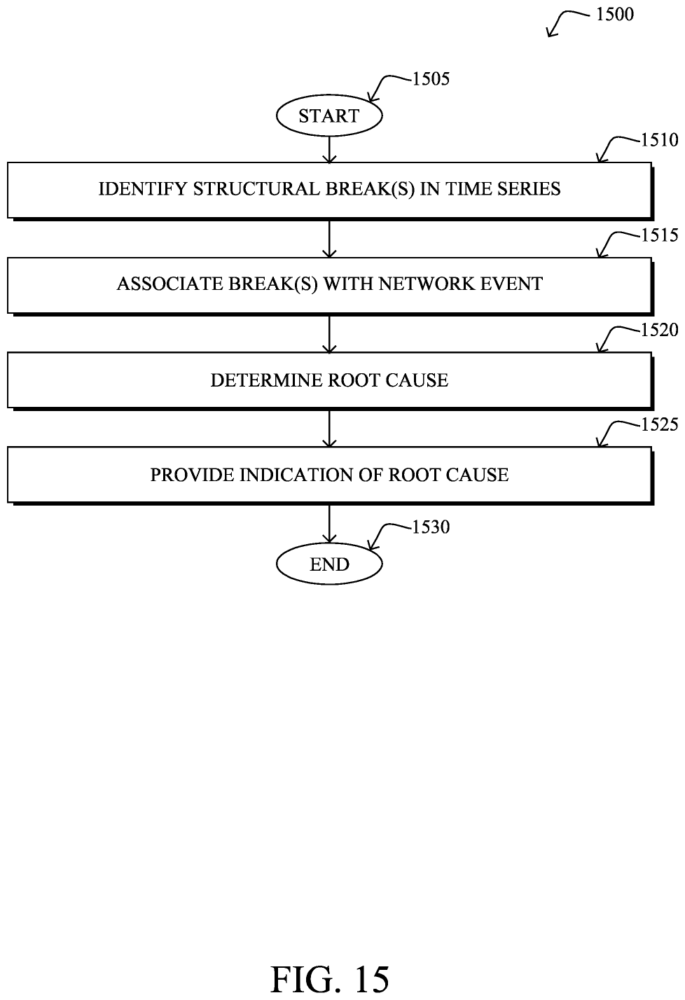

FIG. 15 illustrates an example simplified procedure for using a DFRE to analyze a time series, in accordance with one or more embodiments described herein. For example, a non-generic, specifically configured device (e.g., device 200), such as a networking device (e.g., a router, a network controller, a server, etc.), may perform procedure 1500 by executing stored instructions (e.g., DFRE process 248). The procedure 1500 may start at step 1505, and continues to step 1510, where, as described in greater detail above, the device may execute a DFRE to identify one or more structural breaks in a time series for a particular metric regarding the computer network (e.g., EVPN counters, tunnel counters, etc.).

At step 1515, as detailed above, the DFRE may associate the one or more structural breaks in the time series with a network event. For instance, the DFRE may determine that the structural break(s) are attributable to a link failure, memory leak, ECMP imbalance, route flap, or the like.

At step 1520, the DFRE may determine, using symbolic reasoning, a root cause for the network event based on a symbolic knowledge base maintained by the DFRE, as described in greater detail above. In some embodiments, the DFRE may evaluate the causal connections between network conditions or events, to determine the root cause. For instance, the knowledge base may be seeded with expert knowledge regarding how problems in the network are related (e.g., that packet drops are ultimately attributable to a router in the network overheating). In various embodiments, the device may repeat steps 1510 and 1515 any number of times across a variety of different time series for different metrics in the network, to assess the causal connections between their various events. For instance, network events observed at one router may be causally related to other network events associated with an upstream device on the same path as the router.

As step 1525, as detailed above, the DFRE may provide an indication of the root cause determine for the network event to one or more devices. For instance, the DFRE may provide the indication to a user interface operated by a network administrator or technician, as part of an alert. In other instances, such as in the case of a self-healing network, the DFRE may provide the indication to one or more devices, to initiate a configuration change to the network (e.g., to reroute traffic around a failing device, etc.). Procedure 1500 then ends at step 1530.

It should be noted that while certain steps within procedure 800 may be optional as described above, the steps shown in FIG. 8 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques herein, therefore, introduce a deep fusion reasoning engine (DFRE) configured to assess time series information regarding a network or other physical system. In some aspects, the techniques herein leverage semantic reasoning (e.g., NARS, etc.) and machine learning model(s) (e.g., linear, exponential, Gaussian, neural networks, etc.), to perform the time series analysis and identify a root cause of one or more detected network events.

While there have been shown and described illustrative embodiments that provide for a DFRE for time series analysis, it is to be understood that various other adaptations and modifications may be made within the spirit and scope of the embodiments herein. For example, while certain embodiments are described herein with respect to analyzing breaks in time series, the techniques can be extended without undue experimentation to other time series characteristics or features, as well, such as continuous.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
identifying, by a reasoning engine executed by a device, one or more structural breaks in a time series for a particular metric regarding a computer network;
associating, by the reasoning engine, the one or more structural breaks in the time series with a network event;
determining, by the reasoning engine and using symbolic reasoning, a root cause for the network event based on a symbolic knowledge base maintained by the reasoning engine; and
providing, by the reasoning engine, an indication of the root cause determined for the network event to one or more devices.

2. The method as in claim 1, wherein associating, by the reasoning engine, the one or more structural breaks in the time series with the network event comprises:
clustering the one or more structural breaks by type of structural break.

3. The method as in claim 1, wherein the reasoning engine identifies the one or more structural breaks in the time series by:
decomposing the time series into different sets of linear decompositions; and
applying competing hypothesis testing to the different sets of linear decompositions, to select a particular linear decomposition, wherein the one or more structural breaks are based on the particular linear decomposition.

4. The method as in claim 1, wherein the network event is associated with an event category comprising at least one of: buffer, interface, throughput, control plane, routing or forwarding information base, network policy, physical device, environmental factors, discard, or a particular network layer.

5. The method as in claim 1, wherein associating the one or more structural breaks in the time series with the network event comprises:
analyzing the time series at different timescales to update the symbolic knowledge base.

6. The method as in claim 1, wherein associating the one or more structural breaks in the time series with the network event comprises:
identifying, based in part on the one or more structural breaks, a leading and trailing indicator of the network event.

7. The method as in claim 1, determining the root cause for the network event comprises:
identifying a plurality of network events by analyzing a plurality of time series for different metrics regarding the computer network; and
evaluating a causal connection between the network event and the plurality of network events.

8. The method as in claim 1, wherein identifying the one or more structural breaks in the time series comprises:
decomposing the time series by applying binary segmentation to the time series.

9. The method as in claim 1, wherein the root cause corresponds to a malfunctioning device in the computer network.

10. The method as in claim 1, wherein providing the indication to the one or more devices comprises:
sending an alert indicative of the root cause to a user interface.

11. An apparatus, comprising:
a network interface to communicate with a computer network;
a processor coupled to the network interface and configured to execute one or more processes; and
a memory configured to store a process that is executed by the processor, the process when executed configured to:
identify, by a reasoning engine executed by the apparatus, one or more structural breaks in a time series for a particular metric regarding the computer network;
associate, by the reasoning engine, the one or more structural breaks in the time series with a network event;
determine, using symbolic reasoning, a root cause for the network event based on a symbolic knowledge base maintained by the reasoning engine; and
provide, by the reasoning engine, an indication of the root cause determined for the network event to one or more devices.

12. The apparatus as in claim 11, wherein the apparatus associates, by the reasoning engine, the one or more structural breaks in the time series with the network event by:
clustering the one or more structural breaks by type of structural break.

13. The apparatus as in claim 11, wherein the reasoning engine identifies the one or more structural breaks in the time series by:
decomposing the time series into different sets of linear decompositions; and
applying competing hypothesis testing to the different sets of linear decompositions, to select a particular linear decomposition, wherein the one or more structural breaks are based on the particular linear decomposition.

14. The apparatus as in claim 11, wherein the network event is associated with an event category comprising at least one of: buffer, interface, throughput, control plane, routing or forwarding information base, network policy, physical device, environmental factors, discard, or a particular network layer.

15. The apparatus as in claim 11, wherein the apparatus associates, by the reasoning engine, the one or more structural breaks in the time series with the network event by:
analyzing the time series at different timescales to update the symbolic knowledge base.

16. The apparatus as in claim 11, wherein the apparatus associates, by the reasoning engine, the one or more structural breaks in the time series with the network event by:
identifying, based in part on the one or more structural breaks, a leading and trailing indicator of the network event.

17. The apparatus as in claim 11, the apparatus determines the root cause for the network event by:
identifying a plurality of network events by analyzing a plurality of time series for different metrics regarding the computer network; and
evaluating a causal connection between the network event and the plurality of network events.

18. The apparatus as in claim 11, wherein identifying the one or more structural breaks in the time series comprises:
decomposing the time series by applying binary segmentation to the time series.

19. The apparatus as in claim 11, wherein the apparatus provides the indication to the one or more devices by:
sending an alert indicative of the root cause to a user interface.

20. A tangible, non-transitory, computer-readable medium storing program instructions that cause a reasoning engine to execute a process comprising:
identifying, by the reasoning engine, one or more structural breaks in a time series for a particular metric regarding a computer network;
associating, by the reasoning engine, the one or more structural breaks in the time series with a network event;
determining, by the reasoning engine and using symbolic reasoning, a root cause for the network event based on a symbolic knowledge base maintained by the reasoning engine; and
providing, by the reasoning engine, an indication of the root cause determined for the network event to one or more devices.
